(19) United States
(12) Patent Application Publication
(10) Pub. No.: US 2026/0017744 A1
(43) Pub. Date: Jan. 15, 2026

(54) GENERATING NON-FUNGIBLE TOKENS FOR SWEEPSTAKES GAMING

(71) Applicant: Primero Games, LLC, Norcross, GA (US)

(72) Inventor: Michael Mayo Macke, Norcross, GA (US)

(21) Appl. No.: 18/767,618

(22) Filed: Jul. 9, 2024

(51) Int. Cl. G06Q 50/34; G06Q 20/36; G07F 17/32

(52) U.S. Cl. CPC G06Q 50/34; G06Q 20/3672; G07F 17/3211; G07F 17/3237; G07F 17/329

(57) ABSTRACT

The computing device can receive a request for a token. The computing device can present the token. In response to receiving the request for the token, the computing device can generate a scannable code associated with a randomly generated number. The computing device can present a ticket displaying the scannable code. The computing device can perform a determination based on the randomly generated number. Performing the determination can include determining if the randomly generated number is a winning number for a lottery. The computing device can render an outcome on a display based on the determination.

### TECHNICAL FIELD

The present systems and processes generally relate to utilizing computing technology to generate and provide tokens based on the outcome of a game and for use in one or more sweepstakes.

### BACKGROUND

Wagering games and traditional lottery games do not provide prizes or awards for losing outcomes. For example, patrons may play multiple wagering games but only receive prizes or awards for winning outcomes. Further, patrons may only receive a portion of their stake as a prize. Additionally, traditional lottery games provide physical tickets and do not provide an option for digital tickets. Therefore, there is a long-felt but unresolved need for digital lottery tickets that can provide tokens for both winning and losing outcomes.

### BRIEF SUMMARY OF THE DISCLOSURE

Aspects of the present disclosure generally relate to providing tokens for sweepstake-style games. For example, a lottery system can provide one or more tokens in response to an outcome of a wagering game played on a digital gaming system. In response to the outcome of the wagering game, the digital gaming system can generate a request for a token, and the lottery system can fulfill the request by generating the token for the digital gaming system. Tokens can be defined as non-fungible tokens and can be used as entries into one or more sweepstakes. For example, the digital gaming system can complete a game and generate an outcome. the digital gaming system can determine that a particular token should be awarded based on the outcome of the completed game. In response to determining that the token should be awarded, the digital gaming system can generate and send a request for the token to the lottery system. The lottery system can generate the token by minting the token on a blockchain infrastructure. The token can include an asset that defines a particular condition for winning a sweepstakes or lottery and a smart contract that can define features and/or conditions associated with the particular token. Further continuing this example, the digital gaming system can apply the token to the sweepstakes and generate a reward if the sweepstakes is won. The digital gaming system can store one or more tokens in a cryptographic wallet and associate the tokens to a particular patron account stored in a data store of the digital gaming system.

The assets of the tokens can be associated with a particular sweepstakes, a particular game of the digital gaming system, or a combination thereof. The assets can define one or more attributes of a particular sweepstakes, one or more attributes of a particular game, one or more artistic compositions, a component for determining the outcome of a particular sweepstakes, or a combination thereof. Each of the assets of the digital gaming system can be associated with a number. The lottery system can generate a random number through a random number generator. The lottery system can compare the random number to the number associated with each of the assets to select a particular asset. On selecting the particular asset, the lottery system can mint the asset along with a corresponding smart contract on the blockchain infrastructure to generate the token.

The lottery system can send the token to the digital gaming system. The digital gaming system can store the token in the cryptographic wallet associated with the particular patron account. The digital gaming system can render the token on a display of the digital gaming system. The digital gaming system can apply multiple tokens to one sweepstakes, where the sweepstakes requires multiple tokens to generate a winning outcome.

The digital gaming system can determine if the token is a winning entry into the sweepstakes (or a winning lottery ticket into a lottery) in response to an action or input. For example, the digital gaming device and/or computing device can generate a request to apply the token to the sweepstakes and/or lottery. As another example, the digital gaming device and/or computing device can receive an input to reveal the outcome associated with the token. For example, if the token is rendered to appear as a scratch-off ticket (e.g., the asset of the token is a scratch-off ticket or a particular square of a set of squares from a scratch-off ticket), the digital gaming device and/or computing device can receive an input to “scratching off” a portion of the token. As another example, if the token is rendered as a pull tab ticket (e.g., the asset of the token is a pull tab ticket or a particular tab of a set of tabs from a pull tab ticket), the digital gaming device and/or computing device can receive an input to “pulling the tabs off” the digital lottery ticket. In response to receiving these inputs or activating the token, the digital gaming system can determine the outcome of the sweepstakes based on the token.

The computing device and/or the digital gaming device can render the outcome and the token on a display. The computing device and/or the digital gaming device can associate the token with a patron account. For example, the computing device and/or the digital gaming device can record the patron account on a distributed ledger (e.g., blockchain) as the owner of the token.

The above and further features of the disclosed systems and methods will be recognized from the following detailed descriptions and drawings of various examples of the disclosed systems and methods.

### BRIEF DESCRIPTION OF THE FIGURES

The accompanying drawings illustrate one or more examples and/or aspects of the disclosure and, together with the written description, serve to explain the principles of the disclosure. Wherever possible, the same reference numbers are used throughout the drawings to refer to the same or like elements of the disclosed technology, and wherein:

FIG. 1 illustrates an example digital gaming system according to various examples of the present disclosure.

FIG. 2 illustrates an example networked environment according to various examples of the present disclosure.

FIG. 3 illustrates an example overall process for the disclosed system according to various examples of the present disclosure.

FIG. 4 illustrates an example overall process for the disclosed system according to various examples of the present disclosure.

### DETAILED DESCRIPTION

For the purpose of promoting an understanding of the principles of the present disclosure, reference will now be made to the examples illustrated in the drawings and specific language will be used to describe the same. It will, nevertheless, be understood that no limitation of the scope of the disclosure is thereby intended; any alterations and further modifications of the described or illustrated examples, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Exemplary Embodiments

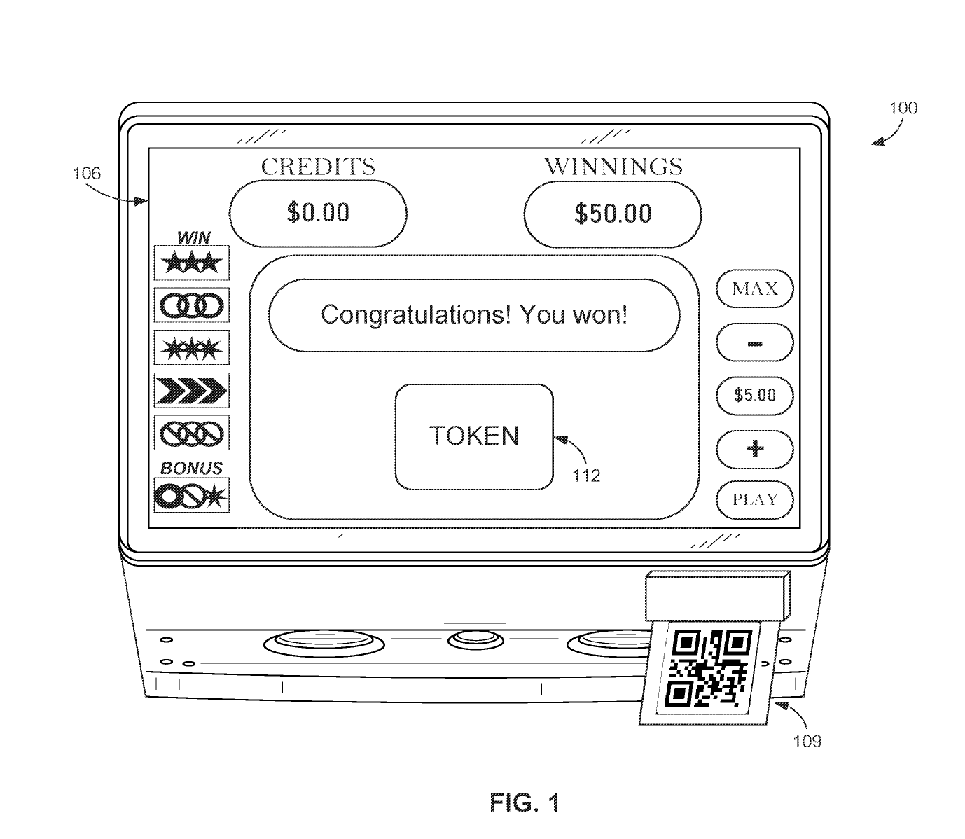

Referring now to the figures, for the purposes of example and explanation of the fundamental processes and components of the disclosed systems and processes, reference is made to FIG. 1, which illustrates a digital gaming system 100. The digital gaming system 100 can function as a central computing device for managing, displaying, and/or facilitating game-of-skill games, game-of-chance games, sweepstakes games, wagering games, lottery games, any particular type of game, or any combination thereof. For example, the digital gaming system 100 can render, enable, and/or manage a virtual chess game. In another example, the digital gaming system 100 can render, enable, and/or manage a virtual basketball game. In another example, the digital gaming system 100 can render, enable, and/or manage a virtual slot machine game. The digital gaming system 100 can limit the types of games playable on the digital gaming system 100 and/or the currencies used to activate the games to abide by local jurisdiction requirements.

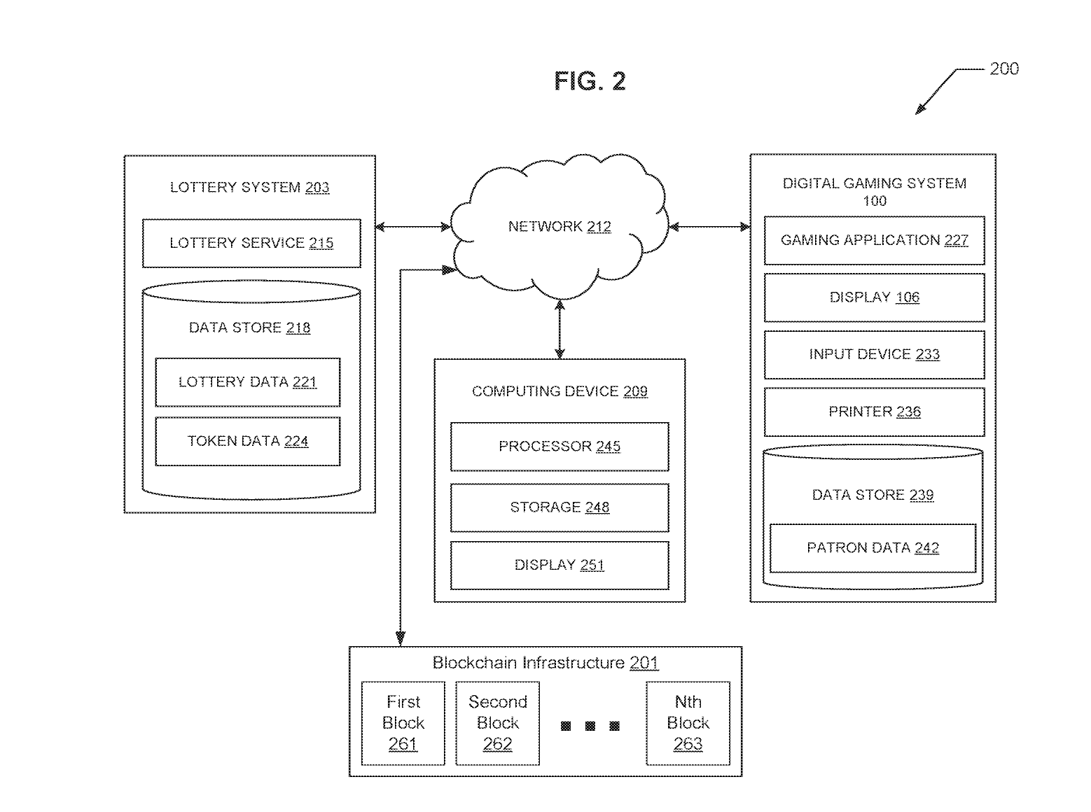

Any particular patron can access the digital gaming system 100 to play particular games. One or more patrons can play on the digital gaming system 100 by each creating a patron account. The digital gaming system 100 can store patron account data associated with each patron in a data store 239 (see FIG. 2). The digital gaming system 100 can link patron accounts to generated rewards, unfinished/ongoing games, and/or any other patron specific feature of the digital gaming system 100. For example, on completion of one or more games, the digital gaming system 100 can link each reward generated by the digital gaming system 100 to a particular patron account.

The digital gaming system 100 can render, manage, and/or play sweepstake-style games. In such a scenario, the digital gaming system 100 can employ fanciful currencies that are obtained for free, as promotional items, and/or through other particular channels to activate a particular game (e.g., a slots-style game) on the digital gaming system 100. On completion of the game and based on the game’s outcome, the digital gaming system 100 can provide the patron, as a reward, an entry into a sweepstakes. The digital gaming system 100 can generate through a lottery system 203 (See FIG. 2) one or more tokens 112 to function as entries into the sweepstakes. The token 112 can include an asset that can be applied to a particular sweepstakes. For example, the token 112 can include a first asset that defines a number associated with a particular bingo sweepstakes. Continuing this example, the digital gaming system 100 can redeem the token 112. On redeeming the token 112, the digital gaming system 100 can identify if the first asset of the token 112 successfully applies to the bingo sweepstakes. Further continuing this example, the digital gaming system 100 can redeem more than one token 112 stored in the particular patron account in an attempt to win the bingo sweepstakes. The digital gaming system 100 can continually redeem tokens 112 against the sweepstakes until the sweepstakes is won. The digital gaming system 100 can generate a reward for the sweepstakes and provide the reward to the patron. In other examples, the sweepstakes can involve a game-of-chance game where the asset can trigger the sweepstakes, and the patron can win the sweepstakes based on particular odds.

The digital gaming system 100 can facilitate a particular wagering game with one or more outcomes (e.g., a slot-style game). For example, the digital gaming system 100 can include a wagering game that has 10 different outcomes for winning combinations. Each of the particular outcomes can include a probability of success. The digital gaming system 100 can select a winning outcome from one or more outcomes. The digital gaming system 100 can select the particular outcome such that the rate at which the digital gaming system 100 selects the outcome is in accordance with the selected outcome’s probability of success. The digital gaming system 100 can, in some scenarios, generate a winning outcome on the completion of a wagering game. The digital gaming system 100 can include particular outcomes for non-winning outcomes. The digital gaming system 100 can include game-of-skill games, where the outcomes of a particular game-of-skill game are dynamically selected such that the user has a particular set of odds at winning and/or losing the particular game-of-skill game.

In response to achieving a winning outcome for a particular game, the digital gaming system 100 can generate a request for one or more tokens 112. For example, on winning a slot-style game, the digital gaming system 100 can generate the request for a particular token with an associated asset. The digital gaming system 100 can send the request to the lottery system 203. The lottery system 203 can generate the token 112 and present the token 112 on a display 106 of the digital gaming system 100. In another example, the digital gaming system 100 can generate a ticket 109 with a readable barcode that, when scanned, loads the token 112 onto the particular computing device that scanned the ticket 109. The digital gaming system 110 can store one or more tokens 112 associated with the patron account in the data store 239 in a cryptographic wallet associated with the patron account.

Referring now to FIG. 2, shown is an example networked environment 200, according to various examples of the present disclosure. The networked environment 200 can include any particular computing system used to support the functionalities of the digital gaming system 100. As will be understood and appreciated, the networked environment 200 shown in FIG. 2 represents merely one approach or example of the present system, and other aspects are used according to various examples of the present system. The networked environment 200 can include, but is not limited to, a blockchain infrastructure 201, the lottery system 203, one or more digital gaming system 100, and/or one or more computing devices 209, all of which can be connected across the network 212.

The elements of the lottery system 203, the computing devices 209, and/or the digital gaming system 206 can be provided via one or more computing devices that can be arranged, for example, in one or more server banks, computer banks, or other arrangements. Such computing devices can be located in a single installation or can be distributed among many different geographical locations. For example, the lottery system 203, the computing devices 209, and/or the digital gaming system 206 can include one or more computing devices that together may include a hosted computing resource, a grid computing resource, or any other distributed computing arrangement. In some cases, the lottery system 203, the computing devices 209, and/or the digital gaming system 206 can correspond to an elastic computing resource where the allotted capacity of processing, network, storage, or other computing-related resources may vary over time. Regardless, the lottery system 203, the computing devices 209, and/or the digital gaming system 206 can include one or more processors and memory having instructions stored thereon that, when executed by the one or more processors, cause the lottery system 203 to perform one, some, or all of the actions, methods, steps, or functionalities provided herein.

The lottery system 203 can include a lottery service 215 and a data store 218. The lottery service 215 can correspond to one or more software executables that can be executed by the lottery system 203 to perform the functionality described herein. Various data can be stored in the data store 218, including but not limited to, the lottery data 221 and the token data 224.

The lottery system 203 can function as a computing resource used to manage tokens 112, generate tokens 112, manage sweepstakes, and/or perform any particular action for the digital gaming system 100. The term lottery can be interchangeable with the term sweepstakes. The lottery system 203 can employ the lottery service 215 to perform the computational requirement for the lottery system 203. For example, the lottery service 215 can manage requests received from the digital gaming system 100, generate smart contracts for one or more tokens 112, manage one or more assets from a set of assets, select an asset for use in a particular token 112, interface with the blockchain infrastructure 201 to mint a particular token 112, manage communications with the blockchain infrastructure 201, manage data related to the tokens 112, generate outcome for particular games performed on the digital gaming system 100, manage sweepstakes, apply tokens 112 to particular sweepstakes, and/or perform any particular task for the lottery system 203.

The data store 218 can manage all particular data associated with the lottery system 203. The data store 218 can include lottery data 221 and token data 223. The lottery data 221 can define any particular information associated with sweepstakes and/or lottery games managed by the lottery system 203 and data associated with the games of the digital gaming system 100. For example, the lottery data 221 can include but is not limited to one or more sweepstakes, one or more outcomes for particular sweepstakes, one or more rules for winning a sweepstakes through particular tokens 112, asset relationship to sweepstakes, asset relationship to particular games of the digital gaming system 100, and/or any other particular data associated with sweepstakes, lottery games, and/or games played on the digital gaming system 100.

The token data 223 can include any particular data associated with one or more tokens 112. For example, the token data 223 can include but is not limited to a list of tokens 112, a list of assets associated with the tokens 112, a list of assets, a set of assets, properties associated with the assets, one or more smart contracts, blockchain infrastructure 201 data associated with one or more tokens 112 (e.g., token IDs, metadata, etc.), and/or any other information associated with the tokens 112. As discussed herein, the assets can be associated with a particular sweepstakes, a particular game of the digital gaming system 100, or a combination thereof. The assets can define one or more attributes of a particular sweepstakes, one or more attributes of a particular game, one or more artistic compositions, a component for determining the outcome of a particular sweepstakes, or a combination thereof. Assets can be received from third-party resources that create sweepstakes, from the digital gaming system 100, artistic resources, and/or any particular resource distributed across the networked environment 200. Each asset can have distinct probabilities of success against its associated sweepstakes, individual probabilities of selection for use in a particular token 112, and/or superior and/or inferior attributes as compared to other assets (e.g., a rare in-game item versus a super rare in-game item).

The lottery service 215 can receive a request from the digital gaming system 100 to generate one or more tokens 112. For example, the lottery service 215 can receive requests for tokens 112 from a gaming application 227 and/or the computing device 209. For example, each time that the gaming application 227 generates an outcome for a wagering game, the gaming application 227 can transmit a request for the token 112 to the lottery service 215. As another example, tokens 112 can be requested or purchased via the gaming application 227 and/or the computing device 209. The gaming application 227 and/or the computing device 209 can receive inputs requesting or purchasing tokens 112 and transmit the requests to the lottery service 215. The lottery service 215 can receive the request from the digital gaming system 100 in response to the digital gaming system 100 completing a particular game and generating an outcome that necessitates the generation of a particular token 112.

On receiving a request to generate the token 112, the lottery service 215 can generate a smart contract associated with the particular token 112. A smart contract can be defined as executable code that defines various characteristics of a particular non-fungible token (e.g., the token 112). The smart contract can define conditions that, when met, will execute the corresponding code to perform some form of action related to the token 112. For example, the smart contract can stipulate conditions for the resale of the token 112, time deadlines for using the token 112 (e.g., a 7-day time window before the token becomes voided), sweepstakes outcome conditions that would change certain attributes associated with the token 112 (e.g., increase payouts for applying a winning token 112 to the particular sweepstakes, generate new rewards, create an enhanced token 112, add a multiplier to the winning amount, provide in-game bonuses for games played on the digital gaming system 100, etc.), and/or any other condition applicable to the tokens 112. The lottery service 215 can generate the smart contract and/or select previously generated smart contracts from the data store 218. The order of generating and/or selecting the smart contract can occur before and/or after the lottery service 215 selects the particular asset for the token 112. For example, some assets can include corresponding smart contracts that the lottery service uses for the token 112. Each condition set by the lottery service 215 can be randomly generated or selected using probabilistic analyses. For example, if the digital gaming system 100 requires that all tokens 112 be used within 30 days of issuance, the lottery service 215 can abide by the requirement of the digital gaming system 100 by including a condition in the smart contract that voids any tokens 112 not used within the initial 30 days period. In another example, the lottery service 215 can include a condition that allows players to receive power boosts for in-game activities performed on the digital gaming system 100. The lottery service 215 can randomly select from a set of multipliers the quantify the power boost condition set in the smart contract. The lottery service 215 can weigh power boosts based on their quality and can reduce the likelihood that stronger boosts are incorporated into the smart contracts as compared to weaker boosts.

The lottery service 215 can select an asset for use in the token 112. For example, each of the assets can be associated with a number. The lottery service 215 can generate a random number through a random number generator. The lottery service 215 can compare the generated number to the number associated with each of the assets to select a particular asset. The lottery service 215 can include the asset in the request for generating the particular token 112. Some assets may be tied to particular outcomes of games played on the digital gaming system 100. For example, on receiving the request from the digital gaming system 100, the lottery service 215 can analyze the request to identify any pre-requested assets used in the requested token 112. The lottery service 215 can select the pre-requested asset for use in the token 112.

Once the lottery service 215 has selected the asset and the smart contract, the lottery service 215 can interface with the blockchain infrastructure 201 to generate the token 112. The blockchain infrastructure 201 can be defined as a distributed ledger system for tracking and recording exchanges performed by the lottery service 215 and/or any other resource of the networked environment 200. The lottery service 215 can employ the blockchain infrastructure 201 to generate the tokens 112 as a non-fungible token. The process for generating the token 112 can be referred to herein as “minting.” Minting can be defined as the process of publishing an asset and a corresponding smart token on the blockchain infrastructure 201. the lottery service 215 can mint both the asset and the smart contract as an NFT (e.g., the token 112) by recording the asset and the corresponding smart contract as one or more blocks on the blockchain infrastructure 201. Once recorded to the blockchain infrastructure 201, the token 112 functions as a non-fungible token.

Once minted to the blockchain infrastructure 201, the lottery service 215 can manage the token 112 through the blockchain infrastructure 201. For example, the blockchain infrastructure 201 can include a public blockchain network (e.g., Bitcoin network, Ethereum network), a private blockchain network, or a hybrid blockchain network. the lottery service 215 can employ the blockchain infrastructure 201 to record at a first block 261 an exchange made between resources of the networked environment 200. For example, exchanges can include but are not limited to an exchange of tokens 112 between patron accounts, between the lottery service 215 and a patron account, and/or between any particular resource. The blockchain infrastructure 201 can include one or more computing devices and one or more memory devices for processing and storing a blockchain ledger. The blockchain ledger can be distributed across one or more computing devices, which may be located in a single location or different locations. The Blockchain infrastructure 201 can include a second block 262 and an Nth block 263. The second block 262 can illustrate a second exchange recorded on the blockchain infrastructure 201 by the lottery service 215, the digital gaming system 100, and/or the computing device 209. The Nth block 263 can illustrate that the lottery service 215 can record more than two exchanges onto the blockchain infrastructure 201. In some embodiments, the blockchain infrastructure 201 is incorporated as a component of the lottery system 203.

Once generated, the lottery service 215 can send the token 112 to a cryptographic wallet associated with the particular patron account. The particular patron account and the associated cryptographic wallet can be located at the patron data 242 of the data store 239. The data store 239 can function substantially similarly to the data store 218. The data store 239 can function as a data repository for the digital gaming system 100. Once the lottery service 215 has transferred the token 112 to the cryptographic wallet of the patron data 242, the digital gaming system 100 can present the corresponding asset of the token 112 on the display 106. The digital gaming system 100 can render the asset of token 112 on the display 106 or print the ticket 109 that includes a scannable code referencing to the token 112 (e.g., a QR Code that points to the the address of the token 112 on the blockchain infrastructure 201). The digital gaming system 100 can render the asset on the display 106 at a first resolution, where the first resolution is lower than a second native resolution of the particular asset.

The lottery service 215 can transmit the token to the digital gaming device 100 or the computing device 209 to present the token 112. For example, the computing device 209 can include a remote computing system (e.g., a cellular device) capable of interfacing with the digital gaming system 100. Continuing this example, the computing device 209 can render the token 112 on an associated display 251.

The lottery service 215 can employ the same asset and/or smart contract to generate distinct tokens for distinct patrons. For example, a first patron can play on the digital gaming system 100 and receive a first token 112 from the lottery service 215. Continuing this example, a second patron can play on the digital gaming system 100 and receive a second token 112 from the lottery service 215. The first token 112 and the second token 112 can include the same asset and same smart contract, but can represent distinct tokens minted on the blockchain infrastructure 201. For example, the first token 112 and the second token 112 can include unique token IDs and can have distinct block addresses stored on the blockchain infrastructure 201.

In some examples, the lottery service 215 can transmit the token 112 to the corresponding patron account stored in the patron data 242. The token 112 can include a non-fungible token that can be recorded on a distributed ledger. The type of token 112 can depend on the token data 224. For example, the tokens 112 can include collectible tokens 112. As another example, the tokens 112 can unlock or provide access to a prize to be used for a wagering game (e.g., a sweepstake) on the digital gaming system 100 or a mobile game on the computing device 209 or the digital gaming system 100. As another example, the tokens 112 can be traded with other patron accounts. As another example, the tokens 112 can include embedded code (e.g., smart contracts) for providing access to an area (e.g., club, lounge) or a discount. As another example, the token 112 provided can be randomly selected by the lottery service 215. As another example, a specific token 112 can be selected in the request received by the lottery service 215. As another example, the tokens 112 can be associated with a rarity (e.g., a probability of randomly selecting the token 112).

The cryptographic wallet stored in the patron data 242 and associated with a particular patron account can store multiple tokens 112. Each token can be associated with one or more assets. For example, the cryptographic wallet can store tokens with similar and/or distinct assets.

Once the patron account receives the token 112, the digital gaming system 100 can receive an input through an input device 233 to activate the token 112. The digital gaming system 100 can activate the token 112 to see if the token 112 generates a winning outcome for the particular sweepstakes. For example, the asset of the token 112 can be compared to the particular sweepstakes. If the asset reaches particular conditions of the sweepstakes, the token 112 can be redeemed as a winning token 112. On winning the sweepstakes, the lottery service 215 can send a reward to the patron account associated with the winning token 112. In another example, the smart contract of the token 112 can include one or more features associated with the sweepstakes and as defined as the conditions of the smart contract. Continuing this example, if the conditions of the smart contract are met, the feature associated with the sweepstakes can be awarded to the patron account associated with the token 112 (e.g., your next entry into the sweepstakes can include a 2X multiplier). In yet another example, the token 112 can define one or more features associated with a particular game of the digital gaming system 100 (e.g., the token 112 defines a spell upgrade for a magic character in a particular game). Continuing this example, the smart contract of the token 112 can stipulate the conditions for activating the feature associated with the particular game (e.g., you first need to collect three lower-level tokens or you need to play for 10 days straight). Further continuing this example, once the conditions of the token 112 have been met (e.g., the patron account has all three lower-level tokens 112 stored in their cryptographic wallet), the smart contract of the token 112 can trigger and the digital gaming system 100 can add the feature (e.g., the spell upgrade) to the patron data 242 associated with the original token 112. Thus, the patron account can how include the updated feature for future use during games played on the digital gaming system 100.

The digital gaming system 100 can facilitate two or more patron accounts trading tokens 112 on an open market. For example, a first patron account can list a first token 112 for trading on the open market of a gaming application 227. Continuing this example, a second patron account can request a trade with the first patron account. The first patron account can accept the trade for the first token 112 in exchange for a second token. The trade request can be submitted to the lottery service 215. The lottery service 215 can update the blockchain infrastructure 201 such that the ownership of the first token 112 and the second token 112 are updated. The digital gaming system 100 can subsequently move the first token 112 into the cryptographic wallet associated with the second patron account and move the second token 112 into the cryptographic wallet of the first patron account.

The lottery service 215 can generate a particular sweepstakes entry. In some examples, the lottery service 215 can generate sweepstakes entries in response to receiving a request for the token 112. For example, the lottery service 215 can create one or more tokens 112 as sweepstakes entries. In other examples, the lottery service 215 can receive a request for a particular sweepstakes entry and the lottery service 215 can provide the token 112 in response to the request for the sweepstakes entry. Each sweepstakes entry can be represented by a scannable code, including but not limited to a QR (e.g., quick response) code, a barcode, two-dimensional code, or any other type of scannable code. The lottery service 215 can generate the scannable codes and associate each scannable code with a randomly generated number. Each randomly generated number can include a predefined number of digits (e.g., 1, 2, 3, 4, 5, 10, 12) or a predefined number of spaces (e.g., each space can include a number between zero and a defined threshold). Each scannable code and associated random number can represent an entry into a lottery or sweepstakes. The lottery service 215 can generate scannable codes and random numbers for multiple lotteries and sweepstakes. In some embodiments, each lottery can include different odds (e.g., chances of winning) and different costs (e.g., free, $1 per scannable code, $2 per scannable code, $5 per scannable code). Each scannable code and randomly generated number can be saved as the lottery data 221.

The lottery service 215 can determine if a randomly generated number won a lottery or sweepstakes. The lottery service 215 can generate one or more random numbers as winning lottery numbers. The lottery service 215 can compare the winning lottery numbers to the randomly generated numbers associated with scannable codes to determine if any of the randomly generated numbers match the winning lottery numbers. If the lottery service 215 determines that one of the randomly generated numbers matches the winning lottery numbers, the lottery service 215 can transmit the winning outcome to the digital gaming system 100 or the computing device 209. If the lottery service 215 determines that the randomly generated numbers do not match the winning lottery numbers, the lottery service 215 can transmit the losing outcome to the digital gaming system 100 or the computing device 209. In some embodiments, the lottery service 215 can randomly select one or more of the randomly generated numbers associated with scannable codes and saved as the lottery data 221 as the winning numbers.

The lottery service 215 can determine a token (e.g., a non-fungible token) based on the lottery and the outcome. The lottery service 215 can determine the token based on the token data 224. For example, the lottery service 215 can determine different types of tokens for different types of lotteries with different odds and costs. As another example, the lottery service 215 can determine different types of tokens depending if the outcome is a winning outcome or a losing outcome. The lottery service 215 can transmit the token to the digital gaming system 100 or the computing device 209.

According to various embodiments, the digital gaming system 100 can include any device capable of accessing network 212 including, but not limited to, a computer, smartphone, tablets, or other device. The digital gaming system 100 can be a gaming cabinet, an amusement device, a slot machine, or other gaming device with a processor-based system such as a computer system. The digital gaming system 100 can include a processor and a data store 239. The digital gaming system 100 can include a display 230 on which various user interfaces can be rendered to allow users to configure, monitor, control, and command various functions of the gaming application 227. The digital gaming system 100 can include the input device 233 for a user to provide various inputs (e.g., selections, wagers, credentials). The input device 233 can include one or more buttons, touch screens including three-dimensional or pressure-based touch screens, camera, finger print, scanners, accelerometer, retinal scanner, gyroscope, magnetometer, or other input devices. The input device 233 can also include a bill acceptor, a player tracking module, a ticket printer, or some other device. The digital gaming system 100 can include a printer 236 for printing tickets. The data store 239 can store data from the digital gaming system 100, including but not limited to the patron data 242.

In various embodiments, digital gaming system 100 can include multiple computing devices. Regardless, the digital gaming system 100 can include one or more processors and memory having instructions stored thereon that, when executed by the one or more processors, cause the digital gaming system 100 to perform one, some, or all of the actions, methods, steps, or functionalities provided herein. The digital gaming system 100 can be configured to execute various applications, such as the gaming application 227 and/or other applications. The gaming application 227 may be executed by the digital gaming system 100, for example, to access network content served up by the digital gaming system 100, and/or other servers, thereby rendering various user interfaces on the display 230. While the specification discusses various functionality as being performed by the gaming application 227, the lottery service 215, or the computing device 209, it is understood that this functionality may be performed by the gaming application 227, the lottery service 215, the computing device 209, or all in coordination.

The gaming application 227 can receive bets and generate outcomes for wagering games. In response to generating an outcome, the gaming application 227 can transmit a request for a token to the lottery service 215. The gaming application 227 can authenticate the user via a player tracking module, a radio frequency identifier (RFID) reader, a card reader, a near field communication (NFC), such as Bluetooth circuitry, Wi-Fi circuitry, or other wireless antenna-based technology. In some embodiments, the patron can insert a patron tracking card into the digital gaming system 100 to authenticate the patron account. In another embodiment, the digital gaming system 100 can read a user identifier associated with the patron from using near field communication (NFC). In some embodiments, the gaming application 227 can authenticate the credentials provided against the patron data 242.

According to various embodiments, the computing device 209 can include any device capable of accessing network 212 including, but not limited to, a computer, smartphone, tablets, or other device. The computing device 209 can include a processor 245 and storage 248. The computing device 209 can include a display 251 on which various user interfaces can be rendered to allow users to configure, monitor, control, and command various functions of networked environment 200. In various embodiments, computing device 209 can include multiple computing devices. Regardless, the computing device 209 can include one or more processors and memory having instructions store thereon that, when executed by the one or more processors, cause the computing device 209 to perform one, some, or all of the actions, methods, steps, or functionalities provided herein.

The gaming application 227 and the computing device 209 can transmit requests for tokens to the lottery service 215 and receive tokens and scannable codes from the lottery service 215. The gaming application 227 and the computing device 209 can render or display the digital lottery ticket to appear as a traditional lottery ticket, including but not limited to a scratch off lottery ticket or a pull tab lottery ticket. The gaming application 227 and the computing device 209 can receive inputs to reveal the outcome of the lottery tickets. For example, the gaming application 227 and the computing device 209 can receive inputs to “scratch off” or “pull the tabs off” the digital lottery ticket. As another example, the gaming application 227 and the computing device 209 can scan the scannable code or access a custom URL associated with the scannable code. In response to receiving the inputs, the gaming application 227 and the computing device 209 can transmit a request to the lottery service 215 for the outcome.

The gaming application 227 and the computing device 209 can receive the outcome and the tokens from the lottery service 215. The gaming application 227 and the computing device 209 can render or display the outcome and token on the displays. The gaming application 227 and the computing device 209 can associate the token with a patron account. For example, the gaming application 227 and the computing device 209 can record the patron account on a distributed ledge (e.g., blockchain) as the owner of the token.

The network 212 can include, for example, the Internet, intranets, extranets, wide area networks (WANs), local area networks (LANs), wired networks, wireless networks, or other suitable networks, etc., or any combination of two or more such networks.

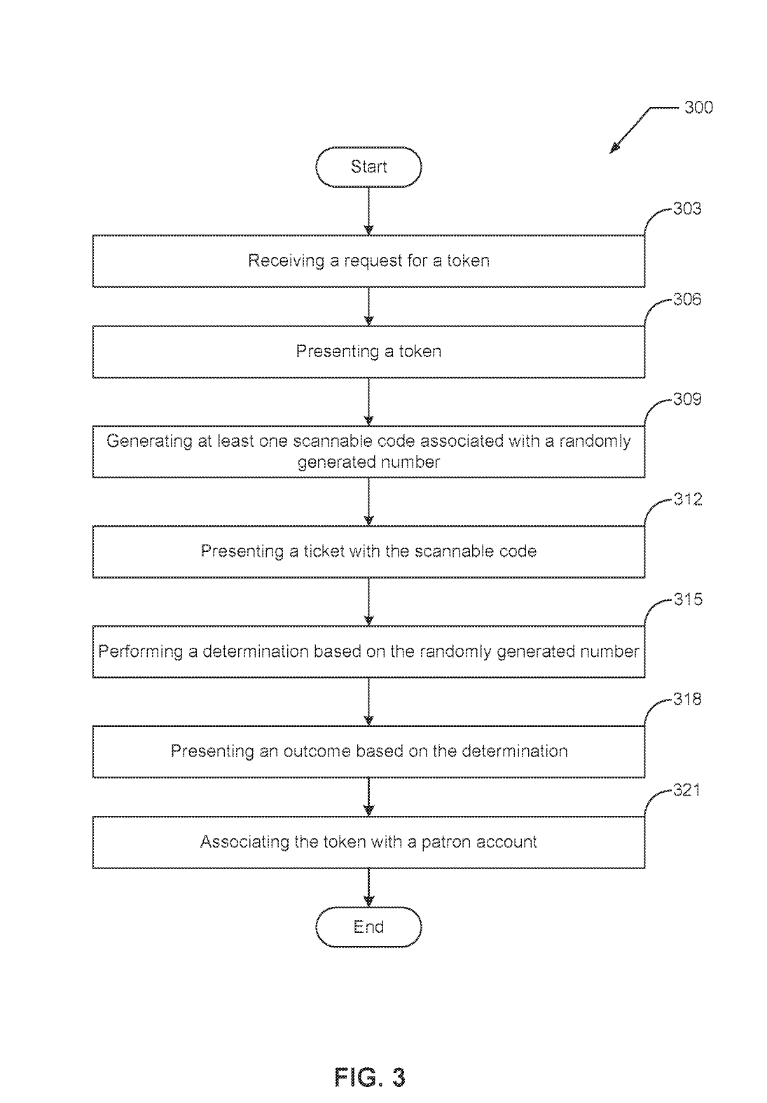

Referring now to FIG. 3, a flowchart of a process 300 according to various embodiments of the present disclosure. As will be understood by one having ordinary skill in the art, the steps and processes shown in FIG. 3 may operate concurrently and continuously, are generally asynchronous and independent, can be performed in part or in whole by a combination of one or more of the lottery system 203, the digital gaming system 100, and the computing device 209 and are not necessarily performed in the order shown and various steps can be executed linearly or in parallel. Process 300 can be performed entirely, partially, or in coordination with the lottery service 215 and the gaming application 227.

At step 303, the process 300 can include receiving a request for a token. The lottery service 215 can receive a request for a token. The lottery service 215 can receive the request from the gaming application 227 or the computing device 209. For example, the gaming application 227 can generate an outcome for a wagering game. In response to generating the outcome for the wagering game, the gaming application 227 can transmit a request for a token to the lottery service 215. As another example, the digital gaming system 100 or the computing device 209 can receive an input (e.g., a selection) from a user for a scannable code and transmit the request to the lottery service 215. The digital gaming system 100 or the computing device 209 can receive a payment from a user or patron and in response to receiving the payment, the digital gaming system 100 or the computing device 209 can transmit a request for the token to the lottery service 215.

At step 318, the process 300 can include presenting a token. The digital gaming system 100 or the computing device 209 can present or render the token. The token can include a non-fungible token. In some embodiments, the non-fungible token can include an associated value (e.g., cash value, points for a game). The token can depend on rules saved in the token data 224. The digital gaming system 100 can render or present the token on the display 230 or the computing device 209 can render or present the token on the display 251.

At step 309, the process 300 can include generating a scannable code associated with a randomly generated number. The lottery service 215 can generate a scannable code associated with a randomly generated. The scannable code can include a QR (e.g., quick response) code, a barcode, two-dimensional code, or any other type of scannable code. Each scannable code can be associated with a randomly generated number. Each randomly generated number can include a predefined number of digits (e.g., 1, 2, 3, 4, 5, 10, 12) or a predefined number of spaces (e.g., each space can include a number between zero and a defined threshold). The lottery service 215 can generate multiple scannable codes at once, each associated with a different or distinct randomly generated number. Each scannable code and randomly generated number can represent or be associated with a chance of winning a lottery or sweepstakes for a reward or prize. The chance of winning can depend on the request received at step 303. As an example, the lottery system 203 can include different lotteries with different odds (e.g., chances of winning) and each lottery can include a different cost (e.g., payment) for requesting a scannable code. The scannable codes and the randomly generated numbers can be saved as the lottery data 221.

At step 312, the process 300 can include presenting a ticket with the scannable code. The digital gaming system 100 or the computing device 209 can present the ticket with the scannable code. For example, the digital gaming system 100 can print the ticket via the printer 236. As another example, the digital gaming system 100 can present or render the ticket via the display 230. As another example, the computing device 209 can present or render the ticket via the display 251. When presenting or rendering the ticket via a display, the ticket can be rendered as a digital ticket to appear as a scratch off ticket or pull tab ticket. In this example, a ticket can be configured to receive inputs or selections to “scratch off” or “pull the tabs” on the digitally rendered ticket. If the lottery service 215 generated multiple scannable codes, the ticket can include multiple scannable codes.

At step 315, the process 300 can include performing a determination based on the randomly generated number. The lottery service 215 can perform a determination based on the randomly generated number. Performing the determination can include determining if the randomly generated number is a winning number for the lottery. For example, the lottery service 215 can generate multiple randomly generated numbers and each randomly generated number is associated with a chance of winning a lottery. After generating multiple randomly generated numbers, the lottery service 215 can generate a random number or multiple random numbers as winning numbers. When the lottery service 215 generates the winning numbers, the lottery service 215 can compare the winning numbers to the lottery data 221 to determine if any of the previously randomly generated numbers saved in the lottery data 221 match the winning numbers. If any of the previously randomly generated numbers saved in the lottery data 221 match the winning numbers, the lottery service 215 can determine which previously randomly generated numbers saved in the lottery data 221 are winning numbers. In some embodiments, the lottery service 215 can select or identify one or more winning numbers when generating the randomly generated numbers for scannable codes. If a previously randomly generated number is a winning number, the randomly generated number can be associated with a winning outcome. If the previously generated number does not match a winning number, the previously generated number can be considered a losing number and associated with a losing outcome.

The lottery service 215 can perform the determination in response to an action. For example, the lottery service 215 can perform the determination in response to the computing device 209 scanning the scannable code. As another example, the lottery service 215 can perform the determination in response to the digital gaming system 100 or the computing device 209 accessing a destination (e.g., custom URL) associated with the scannable code. As another example, the lottery service 215 can perform the determination in response to receiving a request for the determination from the digital gaming system 100 or the computing device 209. As another example, the lottery service 215 can perform the determination in response to receiving “scratch off” or “pull the tabs” inputs for a digitally rendered ticket from the digital gaming system 100 or the computing device 209.

When performing the determination, the lottery service 215 can determine a token based on the outcome and the lottery. The token can include a non-fungible token. The lottery service 215 can determine the token based on rules saved in the token data 224. For example, the lottery service 215 can determine the token based on the type of lottery selected when receiving the request for the scannable code at the step 303. As another example, the lottery service 215 can determine the token based on the outcome (e.g., a winning outcome, a losing outcome) determined at step 312.

At step 318, the process 300 can include presenting an outcome based on the determination. The digital gaming system 100 or the computing device 209 can present the outcome based on the determination. The digital gaming system 100 or the computing device 209 can transmit a request for the outcome to the lottery service 215 in response to an action . For example, the computing device 209 can transmit the request to the lottery service 215 when scanning the scannable code. As another example, the digital gaming system 100 or the computing device 209 can transmit a request for the outcome to the lottery service 215 when accessing a custom URL associated with the scannable code. As another example, the digital gaming system 100 or the computing device 209 can transmit a request for the outcome to the lottery service 215 when receiving inputs to “scratch off” or “pull the tabs” for a digitally rendered ticket. The lottery service 215 can transmit a response, including if the outcome is a winning outcome or a losing outcome and the token, back to the digital gaming system 100 or the computing device 209. The digital gaming system 100 can render or present the outcome on the display 230 or the computing device 209 can render or present the outcome on the display 251.

In some embodiments, the token can be presented based on the outcome or in response to the outcome. For example, the type of token can depend on if the outcome is a winning outcome or a losing outcome. In some embodiments, the type of token can depend on the request received at step 303. For example, the request can include different types of lotteries and the token can depend on the type of lottery selected.

At step 321, the process 300 can include associating the token with a patron account. The digital gaming system 100 or the computing device 209 associate the token with a patron account. To associate the token the patron account, the digital gaming system 100 or the computing device 209 can receive and authenticate credentials associated with a patron account. For example, the gaming application 227 can authenticate the user via a player tracking module, a radio frequency identifier (RFID) reader, a card reader, a near field communication (NFC), such as Bluetooth circuitry, Wi-Fi circuitry, or other wireless antenna-based technology. In some embodiments, the patron can insert a patron tracking card into the digital gaming system 100 to authenticate the patron account. In another embodiment, the digital gaming system 100 can read a user identifier associated with the patron from using near field communication (NFC). In some embodiments, the gaming application 227 can authenticate the credentials provided against the patron data 242. As another example, the computing device 209 can authenticate the credentials provided against the patron data 242.

The token can be associated with the patron account. For example, the patron account can be recorded on a distributed ledger (e.g., blockchain) as the owner of the token. As another example, the token can be associated with or held by a token account (e.g., NFT wallet, blockchain-based wallet). As another example, the token can be saved to a patron account. The token can be configured for trading and selling with other patron accounts.

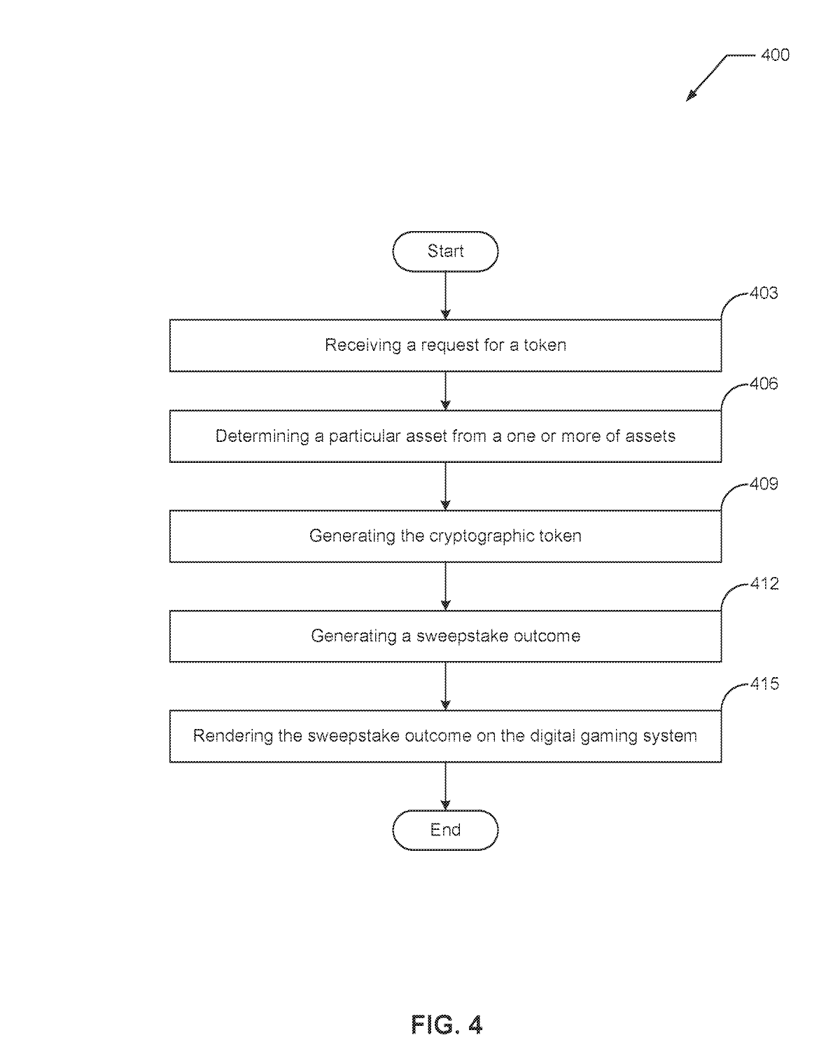

Referring now to FIG. 4, illustrated is a flowchart of a process 400, according to various examples of the present disclosure. The flowchart of the process 400 can illustrate a technique for generating the token 112 and identifying if the token 112 corresponds with a winning outcome of a particular sweepstakes. Any particular service of the networked environment 200 can perform the functionalities described in the process 400.

At box 403, the process 400 can include receiving a request for a particular token 112. The lottery service 215 can receive a request for a particular token 112 from the digital gaming system 100 after the completion of a particular game. For example, the digital gaming system 100 can complete a game and determine a particular winning outcome. The digital gaming system 100 can generate a request for the token 112 as a reward for the winning outcome.

At box 406, the process 400 can include determining a particular asset from one or more assets based on a random number generation. The lottery service 215 can determine the particular asset from one or more assets based on a random number. The lottery service 215 can assign a particular number to one or more assets stored in the data store 218. The lottery service 215 can generate a random number using the random number generator. The lottery service 215 can compare the random number to the particular numbers assigned to each of the assets stored in the data store 218. On determining if the random number matches with the particular number of a particular asset, the lottery service 215 can select the particular asset.

At box 409, the process 400 can include generating the token 112 corresponding to the particular asset. The lottery service 215 can generate the token corresponding to the particular asset. The lottery service 215 can generate and/or select a smart contract for the particular asset. For example, the lottery service 215 can generate a smart contract stipulating particular conditions for the token 112. In another example, the lottery service 215 can identify from the request a particular pre-selected service contract for use in generating the token 112. On determining the smart contract for the particular asset, the lottery service 215 can employ the blockchain infrastructure 201 to mint the token 112. Once minted, the lottery service 215 can send the token 112 to the digital gaming system 100 for storage in the cryptographic wallet associated with the particular patron account that requested the token 112.

At box 412, the process 400 can include generating a sweepstakes outcome from a set of sweepstakes outcomes for a particular sweepstakes game based on the generation of the token 112. The digital gaming system 100 can generate the sweepstakes outcome from the set of sweepstakes outcomes for the particular sweepstakes game based on the generation of the token 112. The digital gaming system 100 can receive an input from the input device 233 to apply the token 112 to the particular sweepstakes. The digital gaming system 100 can identify if the token 112 matches any conditions associated with the particular sweepstakes to produce a winning outcome. In determining that the particular sweepstakes does include conditions associated with the token 112 (e.g., having matching assets), the digital gaming system 100 can determine a winning outcome for the particular sweepstakes. In another example, the sweepstakes can stipulate conditions required to trigger a condition of the smart contract of the token 112. Once the conditions stipulated by the sweepstakes and the smart contract are met, the smart contract may trigger, and the digital gaming system 100 may generate a winning outcome for the particular sweepstakes.

At box 415, the process 400 can include rendering the sweepstakes outcome and the token 112 on a display 106. The digital gaming system 100 can render the sweepstakes outcome and the token 112 on the display 106. The digital gaming system 100 can render the token 112 and/or the asset of the token 112 at a resolution lower than the native resolution of the particular asset.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include non-transitory computer-readable media for carrying or having computer-executable instructions or data structures stored thereon. Such computer-readable media can be any available media which can be accessed by a computer, or downloadable through communication networks. By way of example, and not limitation, such computer-readable media can include various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions include, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The processing unit can include one or more hardware processors. The computer will typically include one or more data storage devices for reading data from and writing data to. The data storage devices provide nonvolatile storage of computer-executable instructions, data structures, program modules, and other data for the computer.

Computer program code that implements the functionality described herein typically includes one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In some embodiments, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein. While thresholds are discussed herein as being met when the threshold is exceeded, the system may determine a threshold is met when a value meets or exceeds the threshold.

Clause 1. A system, comprising: a display; a memory device; and at least one computing device communicatively coupled to the memory device and the display, the at least one computing device being configured to: receive a request for a cryptographic token; determine a particular asset of a plurality of assets based on a random number generation; generate the cryptographic token corresponding to the particular asset; generate a sweepstakes outcome from a set of sweepstakes outcomes for a particular sweepstakes game based on the generation of the cryptographic token; and render the sweepstakes outcome and the cryptographic token on a display.

Clause 2. The system of clause 1 or any other clause herein, wherein the at least one computing device is further configured to associate the cryptographic token with a patron account.

Clause 3. The system of clause 2 or any other clause herein, wherein the patron account comprises a cryptographic wallet.

Clause 4. The system of clause 2 or any other clause herein, wherein the patron account is associated with a plurality of other cryptographic tokens individually corresponding to a respective one of the plurality of assets.

Clause 5. The system of clause 1 or any other clause herein, wherein each of the plurality of assets are individually associated with a respective probability of a plurality of probabilities.

Clause 6. The system of clause 1 or any other clause herein, wherein the at least one computing device is further configured to generate the cryptographic token by embedding a plurality of computing instructions in the cryptographic token.

Clause 7. The system of clause 6 or any other clause herein, wherein the at least one computing device is further configured to determine a plurality of terms and conditions for the cryptographic token, wherein the plurality of computing instructions comprise a smart contract representing the plurality of terms and conditions.

Clause 8. The system of clause 7 or any other clause herein, wherein the at least one computing device is further configured to: receive a request to acquire a feature for the particular sweepstakes game according to one of the plurality of terms and conditions; and enable the feature for the particular sweepstakes game automatically according to the one of the plurality of terms and conditions.

Clause 9. A method, comprising: receiving, via one of one or more computing devices, a request for a cryptographic token; determining, via one of the one or more computing devices, a particular asset of a plurality of assets based on a random number generation; generating, via one of the one or more computing devices, a cryptographic token corresponding to the particular asset; generating, via one of the one or more computing devices, a sweepstakes outcome from a set of sweepstakes outcomes based on the generation of the cryptographic token; and rendering, via one of the one or more computing devices, the sweepstakes outcome and the cryptographic token on a display.

Clause 10. The method of clause 9 or any other clause herein, wherein rendering the cryptographic token on the display comprises rendering the particular asset on the display.

Clause 11. The method of clause 9 or any other clause herein, wherein the particular asset is rendered at a first resolution on the display that is lower than a second native resolution of the particular asset.

Clause 12. The method of clause 9 or any other clause herein, wherein the cryptographic token is a nonfungible token.

Clause 13. The method of clause 9 or any other clause herein, further comprising recording, via one of the one or more computing devices, the token on a distributed ledger.

Clause 14. The method of clause 9 or any other clause herein, further comprising: determining, via one of the one or more computing devices, a patron account comprises a plurality of cryptographic tokens individually corresponding to individual ones of a particular subset of the set of assets; and authenticating, via one of the one or more computing devices, the patron account for access to a particular service based on the patron account comprising the plurality of cryptographic tokens.

Clause 15. The method of clause 14 or any other clause herein, wherein the particular subset of the set of assets is defined within the plurality of cryptographic tokens.

Clause 16. A non-transitory computer-readable medium embodying a program that, when executed by at least one computing device, cause the at least one computing device to: receive a request for a cryptographic token; determine a particular asset of a plurality of assets based on a random number generation; generate a cryptographic token corresponding to the particular asset; generate a sweepstakes outcome from a set of sweepstakes outcomes based on the generation of the cryptographic token; and render the sweepstakes outcome and the cryptographic token on a display.

Clause 17. The non-transitory computer-readable medium of clause 16 or any other clause herein, wherein the program further causes the at least one computing device to cause a printer to print a ticket comprising a scannable code corresponding to the cryptographic token.

Clause 18. The non-transitory computer-readable medium of clause 16 or any other clause herein, wherein the program further causes the at least one computing device to: receive a value corresponding to the scannable code a computing device scanning the scannable code; and associate the cryptographic token with a patron account corresponding to the computing device.

Clause 19. The non-transitory computer-readable medium of clause 16 or any other clause herein, wherein the program further causes the at least one computing device to: receive a request to trade the cryptographic token in a first patron account with a second cryptographic token in a second patron account; assign the cryptographic token to the second patron account; and assign the second cryptographic token to the first patron account.

Clause 20. The non-transitory computer-readable medium of clause 16 or any other clause herein, wherein each of the plurality of assets are individually associated with a respective probability of a plurality of probabilities.

These and other aspects, features, and benefits of the claims will become apparent from the detailed written description of the aforementioned aspects taken in conjunction with the accompanying drawings, although variations and modifications thereto may be effected without departing from the spirit and scope of the novel concepts of the disclosure.

What is claimed is:

1. A system, comprising:
a display;
a memory device; and
at least one computing device communicatively coupled to the memory device and the display, the at least one computing device being configured to:
receive a request for a cryptographic token;
determine a particular asset of a plurality of assets based on a random number generation;
generate the cryptographic token corresponding to the particular asset;
generate a sweepstakes outcome from a set of sweepstakes outcomes for a particular sweepstakes game based on the generation of the cryptographic token; and
render the sweepstakes outcome and the cryptographic token on a display.

2. The system of claim 1, wherein the at least one computing device is further configured to associate the cryptographic token with a patron account.

3. The system of claim 2, wherein the patron account comprises a cryptographic wallet.

4. The system of claim 2, wherein the patron account is associated with a plurality of other cryptographic tokens individually corresponding to a respective one of the plurality of assets.

5. The system of claim 1, wherein each of the plurality of assets are individually associated with a respective probability of a plurality of probabilities.

6. The system of claim 1, wherein the at least one computing device is further configured to generate the cryptographic token by embedding a plurality of computing instructions in the cryptographic token.

7. The system of claim 6, wherein the at least one computing device is further configured to determine a plurality of terms and conditions for the cryptographic token, wherein the plurality of computing instructions comprise a smart contract representing the plurality of terms and conditions.

8. The system of claim 7, wherein the at least one computing device is further configured to:
receive a request to acquire a feature for the particular sweepstakes game according to one of the plurality of terms and conditions; and
enable the feature for the particular sweepstakes game automatically according to the one of the plurality of terms and conditions.

9. A method, comprising:
receiving, via one of one or more computing devices, a request for a cryptographic token;
determining, via one of the one or more computing devices, a particular asset of a plurality of assets based on a random number generation;
generating, via one of the one or more computing devices, a cryptographic token corresponding to the particular asset;
generating, via one of the one or more computing devices, a sweepstakes outcome from a set of sweepstakes outcomes based on the generation of the cryptographic token; and
rendering, via one of the one or more computing devices, the sweepstakes outcome and the cryptographic token on a display.

10. The method of claim 9, wherein rendering the cryptographic token on the display comprises rendering the particular asset on the display.

11. The method of claim 9, wherein the particular asset is rendered at a first resolution on the display that is lower than a second native resolution of the particular asset.

12. The method of claim 9, wherein the cryptographic token is a nonfungible token.

13. The method of claim 9, further comprising recording, via one of the one or more computing devices, the token on a distributed ledger.

14. The method of claim 9, further comprising:
determining, via one of the one or more computing devices, a patron account comprises a plurality of cryptographic tokens individually corresponding to individual ones of a particular subset of the set of assets; and
authenticating, via one of the one or more computing devices, the patron account for access to a particular service based on the patron account comprising the plurality of cryptographic tokens.

15. The method of claim 14, wherein the particular subset of the set of assets is defined within the plurality of cryptographic tokens.

16. A non-transitory computer-readable medium embodying a program that, when executed by at least one computing device, cause the at least one computing device to:
receive a request for a cryptographic token;
determine a particular asset of a plurality of assets based on a random number generation;
generate a cryptographic token corresponding to the particular asset;
generate a sweepstakes outcome from a set of sweepstakes outcomes based on the generation of the cryptographic token; and
render the sweepstakes outcome and the cryptographic token on a display.

17. The non-transitory computer-readable medium of claim 16, wherein the program further causes the at least one computing device to cause a printer to print a ticket comprising a scannable code corresponding to the cryptographic token.

18. The non-transitory computer-readable medium of claim 16, wherein the program further causes the at least one computing device to:
receive a value corresponding to the scannable code a computing device scanning the scannable code; and
associate the cryptographic token with a patron account corresponding to the computing device.

19. The non-transitory computer-readable medium of claim 16, wherein the program further causes the at least one computing device to:
receive a request to trade the cryptographic token in a first patron account with a second cryptographic token in a second patron account;
assign the cryptographic token to the second patron account; and
assign the second cryptographic token to the first patron account.

20. The non-transitory computer-readable medium of claim 16, wherein each of the plurality of assets are individually associated with a respective probability of a plurality of probabilities.
